(19) United States
(12) Patent Application Publication
(10) Pub. No.: US 2018/0289146 A1
(43) Pub. Date: Oct. 11, 2018

(54) CONSTRUCTION KIT FOR THE PRODUCTION OF BRUSH PRODUCTION MACHINES, BRUSH PRODUCTION MACHINE, AND TYPE SERIES OF BRUSH PRODUCTION MACHINES

(71) Applicant: Zahoransky AG, Todtnau (DE)

(72) Inventors: Christoph Albrecht, Todtnau (DE); Guido Sommer, Wembach (DE); Sven Zeiher, Todtnau (DE); Joachim Kiefer, Todtnau (DE)

(73) Assignee: Zahoransky AG, Todtnau (DE)

(21) Appl. No.: 15/946,908

(22) Filed: Apr. 6, 2018

(30) Foreign Application Priority Data
Apr. 6, 2017 (DE) 102017107457.0

(51) Int. Cl. A46D 3/04; A46D 3/08; A46D 1/04; A46D 1/08; A46D 9/04; B65G 37/00; B65G 47/24

(52) U.S. Cl. CPC A46D 3/04; A46D 3/087; A46D 1/04; B65G 2207/30; A46D 9/04; B65G 37/00; B65G 47/24; A46D 1/08

(57) ABSTRACT

In the technical field of the production of brush production machines (1), a construction kit for the production of brush production machines (1) is inter alia provided. This modular construction kit includes at least one basic module type (2a) and a deflection module type (3a), the modules (2, 3) thereof having standardized connection interfaces 5 by which the modules (3) are inter-coupleable to form a brush production machine (1). Since each of the modules (2, 3, 4) is coupleable to each module of the different module types (2a, 3a, 4a), a large number of different brush production machines (1) can be configured by way of this construction kit, without a particular constructive effort being required to this end.

### INCORPORATION BY REFERENCE

The following documents are incorporated herein by reference as if fully set forth: German Patent Application No. 10 2017 107 457.0, filed Apr. 6, 2017.

### BACKGROUND

The invention relates to a modular construction kit for the production of brush production machines, to a brush production machine, and to a type series of brush production machines.

Brush production machines in the most varied of embodiments are known from the prior art. Depending on customer requirements, the brush production machines can comprise a plurality of individual stations that are typically interconnected in terms of conveying technology. The design and the construction of the brush production machines and the individual stations thereof is performed according to the parameters of the customer. In order to be able to respond to the increasingly variable customer requirements, a significant effort in terms of the construction and the adaptation of existing machine concepts may be required.

### SUMMARY

It is therefore an object of the invention to achieve a modular construction kit, a brush production machine, and a type series of brush production machines which enable brush production machines that are configured in a customer-specific manner to be produced in a simpler manner.

This object is achieved by a modular construction kit for the production of brush production machines by way of the means and features of the independent claim directed toward a modular construction kit. In order for this object to be achieved, a modular construction kit for the production of brush production machines is provided which in particular comprises at least one basic module type and one deflection module type, wherein the modules of the module types of the construction kit have mutually compatible connection interfaces by way of which the modules are inter-coupleable such that a multiplicity of different brush production machines of modular construction are producible by way of the construction kit.

A basic module in this context can be an individual module of the brush production machine of modular construction, said individual module combining individual assembly groups of the brush production machine and specific functional units for carrying out processing and/or handling steps which are used in the production of brushes and are assigned to said individual module. Such functional units can include, for example, material fillers, material boxes, stuffing units, processing or finishing units or apparatuses, and cleaning units, embellishing units and quality monitoring units.

The functions of a material filler can be, for example, storing filament pucks, the so-called de-sheathing of said pucks, that is to say the removal of a plastics band which holds the bristle filaments together, and the singularizing or feeding, respectively, of the bristle filaments into a coupled material box.

The material boxes store individual filament bundles which from pucks that are inserted automatically or manually are pushed into the so-called ducts of the material boxes.

Milling apparatuses and/or tumbling polishers, or else other sanding apparatuses, can be used as processing or finishing units, or as finishing apparatuses.

A deflection module in this context can be an individual module of the brush production machine of modular construction, a change in the transport direction of workpieces in the transportation thereof between and/or through the individual modules of a brush production machine being able to be effected by way of said deflection module.

Different brush production machines can be assembled without a large effort in terms of construction in a customer-specific manner from the modular construction kit using only at least two different module types thereof, specifically one basic module type and one deflection module type. This increases the flexibility of the production of brush production machines at an at least constant or even reduced effort in terms of construction and installation. The modules of a module type are standardized, can thus be of the substantially identical basic construction. These modules, according to the customer requirements set, can be selected from the construction kit and be joined so as to form a brush production machine.

The most varied machine concepts can be assembled by combining the module types provided in the construction kit. The different brush production machines of these machine concepts herein can share a significantly higher proportion of identical parts since the commonality potential of the components and/or assembly groups increases. Specific components or assembly groups can have multiple uses on different module types, where a plurality of different components or assembly groups have previously been necessary. Costs in terms of the complexity of brush production systems can be lowered on account of the fewer variants of components and assembly groups to be kept on hand, on account of which more competitive prices can be implemented. By virtue of the fewer number of different components and/or assembly groups, the storage effort at the producer of the brush production machines can also be reduced.

It can be advantageous for the connection interfaces to be disposed on connection sides of the modules of the different module types. Particularly preferably, the connection sides of two modules that are neighboring in the coupled use position face one another. In this way, the connection interfaces can be disposed on connection sides which are disposed between directly neighboring modules of a brush production machine that has been tailored from the construction kit. In this way, the connection interfaces can be disposed so as to be reliably protected against damage and/or manipulation.

The effort for installing a brush production that has been tailored from the construction kit can be reduced when the modules of the different module types on the connection interfaces thereof have coupling elements that are inter-coupleable in particular in a manner without the aid of auxiliary means or in a purely manual manner. The modules by way of these coupling elements can be mechanically, electrically, electronically, in particular in terms of data technology, pneumatically and/or hydraulically inter-coupleable.

The use of coupling elements herein has the advantage that, in particular when the coupling elements are configured as plug connections, the effort in the coupling of the modules can be comparatively minor. The coupling elements, in particular the electrical and/or electronic coupling elements, herein can be configured in such a manner that the construction of a brush production machine from the construction kit can be performed without complex cabling and optionally without an electronic systems technician or an electrical systems technician. In this way, not only the construction of a brush production machine that is tailored from the construction kit, but also a replacement of individual modules of the brush production machine that is composed from a plurality of modules can be simplified.

The inter-coupleable coupling elements on the connection sides of the modules of the different module types can preferably be congruent in terms of the number and/or arrangement thereof. A standardized allocation of the connection sides of the modules with coupling elements can thus be achieved. This can additionally simplify the coupling of individual modules to one another.

The coupling elements are preferably inter-coupleable in a reversibly releasable manner such that a de-coupling of two modules, for example in order for a module to be replaced, can be performed without a great effort.

A basic module of the basic module type can have in each case at least one installation interface for equipping the basic module with functional units. It can furthermore be provided that a basic module of the basic module type is designed in such a manner that said basic module has a plurality of preferably mutually identical installation interfaces for equipping the module with functional units. These installation interfaces can be disposed at various positions on the basic module, in particular on a basic frame of the basic module, and can optionally also be displaceable on said basic module or the basic frame thereof.

The one or plurality of installation interfaces of a module can be equipped with different functional units, depending on the customer requirements. For example, bundle stuffing units with or without material boxes, processing units, for example milling apparatuses and/or tumbling polishers, material fillers and/or feeding and retrieving units for feeding and retrieving bristle carriers and/or finished brushes are used herein as functional units.

The basic modules of a basic module type, in terms of the arrangement and/or selection of the installation interfaces, can be preferably mutually identical. It is furthermore possible that an installation interface is equipped with different functional units, in particular at least with individual functional units of the functional units mentioned above. In this way, the basic modules of a basic module type can indeed be standardized in terms of the basic construction thereof, this assisting in lowering the costs in terms of complexity mentioned above. Despite the high degree of standardization, a high number of different configurations of the basic modules can be implemented by way of basic modules that are designed in such a manner. This can increase the flexibility of the construction kit in terms of the production of different brush production machines and in terms of satisfying the most varied customer requirements.

As in the previous case of a basic module of a basic module type, it can also be provided in the case of a deflection module of the deflection module type that such a deflection module has in each case at least one installation interface or a plurality of in particular mutually identical installation interfaces for equipping the module with functional units. Here too, the installation interfaces can be specified for being equipped with different functional units as have already been mentioned above.

It is particularly advantageous for the installation interfaces which are used in the case of a basic module of a basic module type to be identical to the installation interfaces which are used in the case of the deflection modules of a deflection module type. In this way, existing functional units can be swapped between the modules.

The flexibility in the production of brush production machines from the construction kit can be further increased when the construction kit comprises at least one intermediate module type. An intermediate module of the intermediate module type does not have to be, but can be, configured so as to be free of installation interfaces, and/or have a module length that deviates in comparison to a basic module of the basic module type. For example, manual processing procedures or else checks or quality assurance measures on the workpieces, in particular bristle carriers which have been fitted or partially fitted with bristles, that are transported by way of the intermediate module, can then be carried out on an intermediate module of this type.

When the intermediate modules have a module length that deviates in comparison to the basic modules of the basic module type, said intermediate modules are also suitable for adapting in a simple and uncomplicated manner a brush production machine to constructive conditions at the commissioning site of the brush production machine. Connection interfaces on connection sides of the intermediate modules which permit intermediate modules of the intermediate module type to be interconnected in a simple manner to other intermediate modules or other modules of other module types are also provided in the case of the intermediate module type.

It has already been explained above that basic modules and/or deflection modules of the basic module type, or of the deflection module type, respectively, can be equipped with feeding and retrieving units as functional units. However, it can also be advantageous for the construction kit to comprise at least one feeding and/or retrieving module type. A feeding and/or retrieving module of the feeding and/or retrieving module type can have at least one supply and/or retrieval unit for supplying and/or retrieving material, in particular bristle carriers and/or brush bodies. It is possible herein, for example, to keep on hand one feeding and/or retrieving module type, an automatic supply/and or retrieval unit being provided on the feeding and/retrieving modules of said feeding and/or retrieving module type, and one manual feeding and/or retrieving module type, so as to be able to meet different requirement profiles in the production of tailored brush production machines.

The modules of the different module types of the construction kit can have in each case at least one guide for a transport installation that in terms of conveying technology connects the modules, said transport installation being for workpieces that are to be processed by way of the brush production machine. Such a transport installation can be, for example, a transport chain from a plurality of interconnected transport units for bristle carriers.

It is to be mentioned in this context that the construction kit can have at least one transport installation type having transport units that are freely coupleable, in particular in terms of the number thereof, for the production of transport installations, the modules of a brush production machine that is produced from the construction kit being connectable in terms of conveying technology to said transport installations. In this way, not only almost arbitrary combinations of modules can be assembled from the construction kit, but the individual modules of a brush production machine that is assembled from the construction kit can moreover also be provided with a tailor-made but nevertheless standardized transport installation that can therefore be configured in a comparatively simple manner.

In the case of a deflection module of the deflection module type it can be provided that such a deflection module can in each case have at least one curved and/or angled guide for a transport installation. Such a guide can be, for example, a guide rail or else a guide groove. By way of the guide that is curved and/or angled in such a manner, the transport installation, depending on the design of the guide, can be deflected in particular by 45 degrees, 90 degrees, or 180 degrees. Guides of this type can also be provided on feeding and/or retrieving modules of the feeding and/or retrieving module type.

In particular in the case of a guide that is deflected by 180°, an entry cross section and an exit cross section of a guide of a deflection module, or else of a feeding and/or retrieving module, can be disposed or configured on a connection side of the respective module. In this way, the deflection module of the deflection module type, and feeding and/or retrieving modules, are suitable for deflecting the workpiece flow through the individual modules of the brush production machine that is tailored from the construction kit. In the case of a corresponding arrangement of deflection modules of this type, or else of feeding and/or retrieving modules, a closed revolving transport path for the transport installation can be formed with the aid of the guides of the individual modules.

In particular, in the case of a basic module of the basic module type, and/or of an intermediate module of the intermediate module type, in each case at least two guides can be provided. These guides on the respective module can be mutually spaced apart and/or aligned so as to be mutually parallel. Entry cross sections and exit cross sections of the guides of such a module can be disposed on different connection sides, in particular on opposite connection sides, of the respective module. In this way, the transport unit by way of a first of the at least two guides of a module, can be directed over the module or through the module in the one direction. Upon passing at least one downstream deflection module, the transport installation by way of the second of the at least two guides can then be guided back through or over the module.

It can be advantageous for the guides, by way of the exit cross sections thereof, in the case of modules that are in the use position, to open into the entry cross sections of the guides of directly neighboring modules. In this way, the already previously mentioned closed transport path can be formed by guides of the standardized modules of the different module types. In this way, a transport path of almost arbitrary length can thus be formed from the individual guides, independently of the individual modules from the construction kit that the brush production machine has been tailored from.

A closed revolving transport path can be achieved in the case of a brush production machine which is assembled from at least one basic module and two deflection modules, or from at least one basic module and one deflection module and one feeding and/or retrieving module having a corresponding deflection guide or an angled or curved guide.

The storage costs as well as the costs in terms of variance and/or complexity, can be held particularly low when the modules of a basic module type have the same basic construction, in particular the same basic frame and/or the same encapsulation. The same can apply to the deflection module of a deflection module type, to the intermediate modules of an intermediate module type, and/or to the feeding and/or retrieving modules of a feeding and/or retrieving module type.

The installation of the individual modules so as to form a brush production machine can be particularly simple when the modules of the different module types are in each case configured as autonomously operable units. It can be provided herein that the modules have the electrical and/or electronic installations required for the operation of said modules. Electrical installations of this type can be or comprise, for example, output and/or control units.

It is moreover advantageous for the modules of the different module types of the construction kit to be completely electrically wired and/or be equipped with hydraulic and/or pneumatic lines. This has the particular advantage that even an existing brush production machine that has been tailored from the construction kit can be modified without a great effort and without complex installations, when required. It is conceivable herein, for example, for the layout of the brush production machine to be modified by adding or removing individual modules.

Since each of the modules in this way forms a complete and functional unit, the upgrade, or else the reversal of an upgrade, of a brush production machine that has been assembled from the construction kit can be performed in a comparatively simple manner.

The aforementioned object is also achieved by a brush production machine having one or more features of the invention. In order for the object to be achieved, a brush production machine which in particular is produced from modules of a construction kit, in particular of a construction kit according to the invention, is provided. Due to the brush production machine being produced from modules of a construction kit, the most varied customer requirements can be met and the most varied machine combinations and machine layouts can be implemented at a justifiable effort. Due to the standardization, in particular of the connection interfaces between the individual modules of the different module types, as has been described in detail above, the installation effort can be kept comparatively low, even in the case of large brush production machines which comprise a multiplicity of individual modules.

In the configuration of the brush production machine which can be made from the construction kit, it can be provided that the brush production machine is assembled from at least one deflection module and from at least one basic module. It can be furthermore provided that, apart from the at least one deflection module and from the at least one basic module, a further deflection module and/or a feeding and/or retrieving module of the feeding and/or retrieving module type is provided, the latter preferably having a curved or angled guide for deflecting a transport installation also on or on said module. This way, a brush production machine which has a closed revolving transport path for a transport installation can be achieved, said transport path being assembled from individual guides of the respective modules.

As has already been explained, in the case of inter-coupled modules the guides of the modules of the brush production machine for a transport installation, by way of which workpieces, in particular bristle carriers or brush bodies, can be transported between the individual modules, can form the closed revolving transport path. The transport installation can revolve on this transport path. The transport installation can in particular be a transport chain which is composed of transport units which are interconnected, in particular in an articulated manner.

The object mentioned at the outset is also achieved by a type series of brush production machines having one or more features of the invention directed toward the type series. It is provided in particular here in that the type series is comprised of at least two different brush production machines as have been described in the preceding text as well as in the description and claims that follow. The brush production machines herein can differ from one another in terms of the combination of the modules thereof, in the number of individual modules, and/or in the equipping of individual modules with functional units.

### BRIEF DESCRIPTION OF THE DRAWINGS

Exemplary embodiments of the invention are described in more detail hereunder in connection with the drawing. It is to be mentioned that the invention is not limited to these exemplary embodiments shown. Further exemplary embodiments are derived from the combination of the features of individual or a plurality of claims with one another, and/or with individual or a plurality of features of the exemplary embodiments. In illustrations which in some instances are very schematic:

FIG. 1 shows a plan view of a basic module of the basic module type of the construction kit, wherein two guides that are disposed so as to be mutually parallel, having a transport installation that is illustrated in fragments, and two functional units can be seen on an upper side of the basic module;

FIG. 2 shows a further illustration of a basic module that in comparison to FIG. 1 has been rotated by 180°;

FIG. 3 shows a first configuration of a brush production machine of a type series according to the invention, the former being produced from different modules of the construction kit; and

FIGS. 4-8 show further exemplary embodiments of different brush production machines which are part of the same type series of brush production machines which in turn have been produced by means of one and the same construction kit.

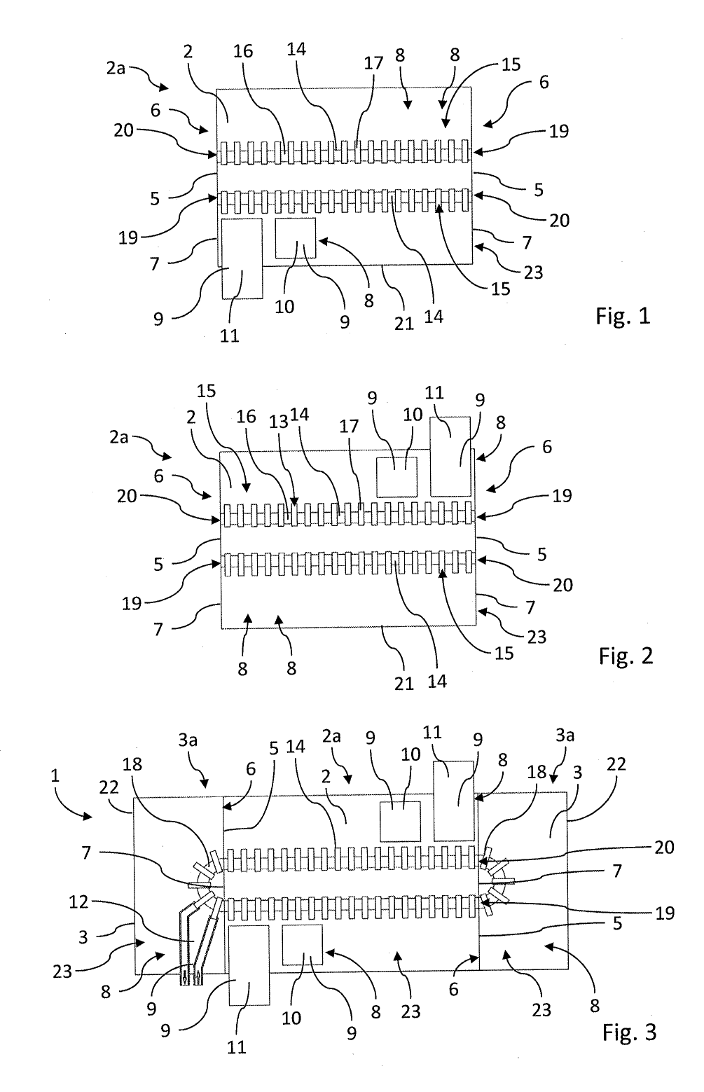

### DETAILED DESCRIPTION OF THE PREFERRED EMBODIMENTS

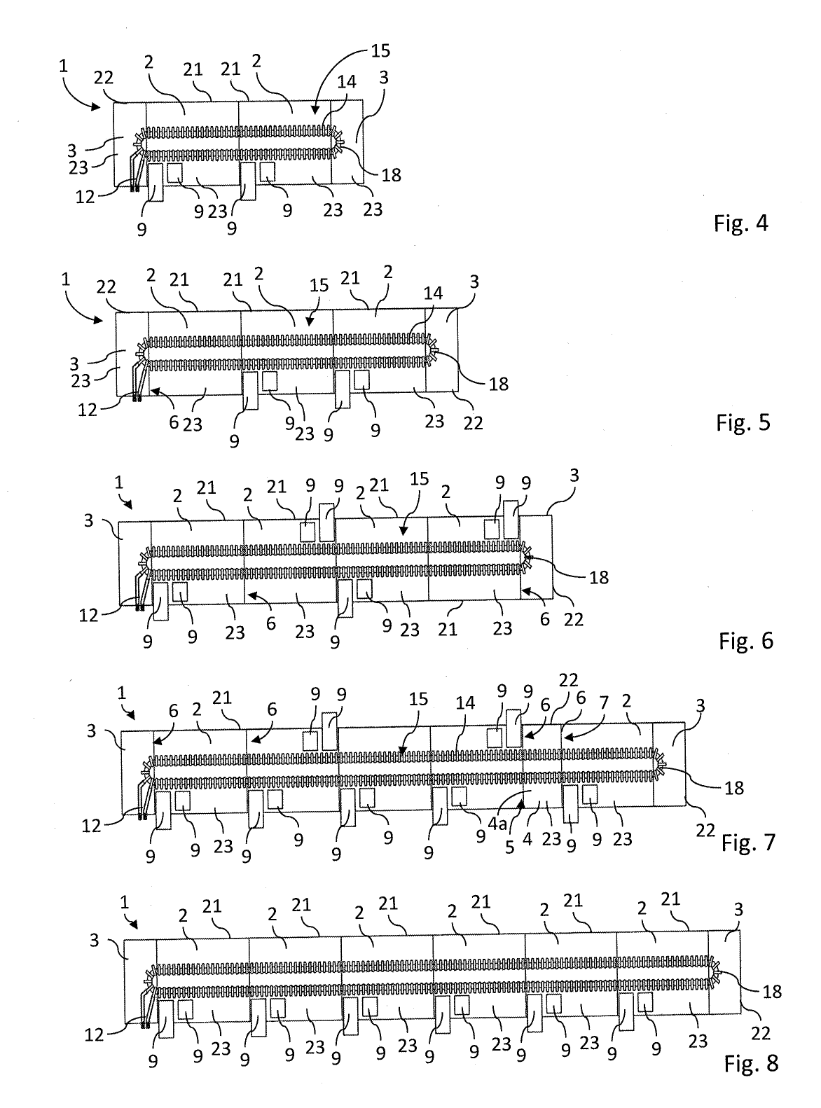

FIGS. 3 to 8 show different exemplary embodiments of brush production machines which in their entirety are in each case identified by the reference sign 1 and which are part of a type series of brush production machines.

All of the brush production machines 1 that are illustrated in FIGS. 3 to 8 herein are produced from modules of the construction kit.

The modular construction kit from which the individual brush production machines 1 have been produced comprises a basic module type 2a and a deflection module type 3a. Furthermore, an intermediate module type 4a is provided, the intermediate modules 4 thereof (cf. FIG. 7) having a module length that deviates in comparison to the basic modules 2 of the basic module type 2a. The module length of the intermediate modules 4 of the intermediate module type 4a herein is smaller than that of the basic modules 2, and corresponds approximately to that of the deflection modules 3.

All of the module types 2a, 3a, 4a of the construction kit have mutually compatible connection interfaces 5. The modules of the different module types 2a, 3a, 4a are inter-coupleable by way of these connection interfaces 5. A multiplicity of different brush production machines 1 of modular construction, such as are illustrated in FIGS. 3 to 8 in order for the type series to be visualized, can be produced in this way with the construction kit.

The connection interfaces 5 are disposed or configured on connection sides 6 of the different modules 2, 3, 4. In the case of a basic module 2 of the basic module type 2a, the connection interfaces 5 are disposed on opposite connection sides 6 that face away from one another. The same applies to the intermediate modules 4 of the intermediate module type 4a. The basic modules 2 and the intermediate modules 4 thus have in each case 2 connection sides 6 such that said modules can be connected on both sides to in each case one adjoining module 2, 3, 4.

The deflection modules 3 of the deflection module type 3a which in FIGS. 3 to 8 are in each case illustrated at the extreme outside, have in each case only one connection side 6 on which connection interfaces 5 for coupling the deflection modules 3 to other modules, above all to the module types 2a, 3a, are disposed.

FIGS. 3 to 8 highlight that the connection sides 6 of two modules 2, 3, 4 that are neighboring in the coupled use position face one another.

The modules 2, 3, 4 of the different module types on the connection interfaces 5 thereof have inter-coupleable coupling elements 7 which are congruent in terms of the number and the arrangement thereof. The different modules 2, 3, 4 can be mechanically, electrically, electronically, in particular in terms of data technology, pneumatically, and/or hydraulically interconnected or inter-coupled with the aid of said coupling elements 7.

The coupling of the individual modules 2, 3, 4 with the aid of the coupling elements 7 herein can preferably be reversibly releasable. The basic modules 2 of the basic module type in the present exemplary embodiment have in each case four installation interfaces 8. These installation interfaces 8 serve for equipping the basic modules 2 with functional units 9.

In the case of the exemplary embodiment of a basic module 2 illustrated in FIG. 3, all of the total of four installation interfaces 8 are equipped with functional units 9. Two of the installation interfaces 8 are provided with bundle stuffing units 10 as functional units 9. The bundle stuffing units 10, apart from a stuffing tool, also comprise a material box for supplying bristle filaments. The remaining installation interfaces 8 of the basic module 2 illustrated in FIG. 3 are equipped with material fillers 11 as functional units 9. The material fillers 11 store, for example, filament pucks and enable the so-called de-sheathing of said pucks. This is to be understood as a removal of a plastics band which holds the bristle filaments in the shape of a puck. The bristle filaments can be singularized with the aid of the material fillers 11 and be transferred to the material box of the bundle stuffing unit 10 that is coupled thereto in the use position.

The installation interfaces 8 present on a basic module 2 are mutually identical. In this way, each of the installation interfaces 8 present can be equipped with different or else with the same functional units 9. This increases the flexibility of the construction kit for the production of brush production machines 1.

Apart from bundle stuffing units 10 and material fillers 11, processing units, material boxes, and/or feeding and retrieving units 12 can also be used as functional units 9. Feeding and retrieving units 12 of this type are disposed, for example, on the deflection modules 3 that are illustrated on the left side in FIGS. 3 to 8. The deflection modules 3 of the deflection module type 3a thus also have in each case at least one installation interface 8 which can be equipped with a functional unit 9, presently with a feeding and/or retrieving unit 12.

The feeding and/or retrieving unit 12 serves for feeding and/or retrieving workpieces, presently bristle carriers 13 to and from the processing process, the latter running in each case within the brush production machines 1 and the individual modules 2, 3, 4. Alternatively or additionally to a deflection module 3 having a feeding and/or retrieving unit 12, a filler and/or retrieval module of a corresponding module type can also be used.

In comparison to the basic modules 2 of the basic module type 2a and to the deflection modules 3 of the deflection module type 3a of the construction kit, the intermediate modules 4 of the intermediate module type 4a are configured so as to be free of installation interfaces. These intermediate modules 4 can serve, for example, for bridging the distance between individual modules 2, 3, 4, or else as a space for the manual post-processing of the workpieces that have been processed by the brush production machine 1.

The construction kit, apart from the different module types 2a, 3a, 4a mentioned above, also has the previously mentioned filler and/or retrieval module type. Filler and/or retrieval modules of this module type are not shown separately in the figures. Said filler and/or retrieval modules are used above all when a brush production machine 1 is to be equipped with complex automated supply devices and retrieval devices. A filler and/or retrieval module of this module type has a cross-sectional area which can correspond approximately to that of a basic module 2 of the basic module type 2a. In the case of the filler and/or retrieval modules of this module type it is provided that the former have at least one supply and/or retrieval unit for supplying and/or retrieving material, in particular bristle carriers and/or brush bodies and/or finished brushes. A supply and/or retrieval unit of this type can be a tray loader, for example, or also be a vibration conveyor or the like supply device.

The individual modules of the different module types 2a, 3a, 4a are in each case equipped with at least one guide 14 or 18 for a transport installation 15 that in terms of conveying technology connects the modules 2, 3, 4 of a brush production machine 1. The transport installation 15 which can be seen in the different brush production machines 1 as illustrated in FIGS. 3 to 8, is a transport chain 16 from a plurality of interconnected transport units 17. In each case one bristle carrier 13 is disposed on each transport unit 17, the former with the aid of the transport installation 15, configured as a transport chain 16, of the respective brush production machine 1 moving between the modules 2, 3, 4 of the brush production machine 1.

The transport installation 15 that is illustrated in the figures is also of modular construction and can be made from the construction kit. For this purpose, the construction kit has at least one transport installation type. The transport installation type comprises transport units 17 that in terms of the number thereof are freely coupleable. With the aid of the construction kit and of the transport installation type, transport installations 15 of different lengths can be tailored for brush production machines 1 of different sizes of a type series, such as are illustrated, for example, in FIGS. 3 to 8 from the freely coupleable transport units 17. The modules 2, 3, 4 of a brush production machine 1 that is produced from the construction kit can be connected in terms of conveying technology with the aid of the transport installations 15.

The deflection modules 3 of the deflection module type 3a illustrated in the figures, but also feeding and retrieving modules of the feeding and/or retrieving module type, have in each case at least one curved guide 18. The different transport installations 15 of the brush production machines 1 according to the exemplary embodiments in the figures can be deflected by 180° with the aid of the curved guides 18. Due to the brush production machines 1 illustrated in FIGS. 3 to 8 having in each case two deflection modules 3 having guides 18 of this type, the guides 14 and 18 can be assembled to form a closed transport path on which the transport installation 15 revolves in the form of an endless transport chain 16.

In the case of the deflection modules 3 it is provided that an entry cross section 19 and an exit cross section 20 of a guide 18 of a deflection module 3 is in each case disposed or configured on the same connection side 6 of the respective deflection module 3.

As has already been explained above, the basic modules 2 of the basic module type 2a, and also the intermediate modules 4 of the intermediate module type 4a, have in each case at least two guides 14. These two guides 14 of the respective modules 2, 4 are mutually spaced apart and moreover are aligned so as to be mutually parallel. The entry cross sections 19 and the exit cross sections 20 of the individual guides 14 are disposed on different connection sides 6 of the respective module 2, 4, specifically on opposite connection sides 6 of the respective module 2, 4 that face away from one another. In this way, a transport installation 15 in the form of a transport chain 16 can be directed through one of the two guides 14 of a module 2, 4 in the one direction, or over the module 2, 4, and with the aid of the second guide 14 be guided back over the respective module 2, 4 in the opposite direction.

The modules 2, 3, 4 of the different module types 2a, 3a, 4a of the construction kit can be interconnected and inter-coupled in such a manner that the guides 14, 18 thereof, by way of the exit cross sections 20 thereof, in the case of modules 2, 3, 4 that are in the use position, open into the entry cross sections 19 of the guides 14, 18 of directly neighboring modules 2, 3, 4. The guides 14, 18 of the modules 2, 3, 4 of the different module types of the construction kit are thus interconnected to form the closed guide path or transport path which can be readily seen in FIGS. 3 to 8.

All of the brush production machines 1 illustrated in the figures are assembled from at least one basic module 2 and two deflection modules 3, the at least one basic module 2 being disposed between the latter two.

In the case of other exemplary embodiments of the brush production machines 1 that can be produced using the construction kit, the former can be assembled from at least one basic module 2 and one deflection module 3, and from one filling and/or retrieving module (not separately illustrated in the figures).

A particularity of the construction kit lies in that the modules 2, 3, 4 of a module type always have the same basic construction, in particular the same basic frame 21, 22. The standardization can be progressed even further when the respective modules 2, 3, 4 of the different basic module types also have the same encapsulation, wherein the different encapsulations of the different module types 2a, 3a, 4a of course are mutually compatible so as to achieve an upgradable, encapsulated processing space of the brush machine 1 to be produced.

While the basic modules 2 have one and the same basic frame 21, the deflection modules 3 are equipped with a correspondingly designed basic frame 22 which presently is smaller as compared to the basic frame 21 of the basic modules 2. By virtue of the comparable size thereof, the deflection modules 3 and the intermediate modules 4 have the same type of basic frame 22 (cf. FIG. 7). However, deviations from this principle are possible.

The installation interfaces 8 that are provided within or on a basic frame 21, 22 are interfaces which are standardized within the construction kit. A basic frame 21, 22 of a module 2, 3, 4 can thus be equipped in a variable manner with different functional units 9. In a typical case, a basic module 2, in particular when the latter is used as a finishing module in the central part of a brush production machine 1, can be equipped with a bundle stuffing unit 10 and a further functional unit 9, for example a processing unit or a finishing unit. However, as is illustrated in FIGS. 3 and 7, by virtue of the total of installation interfaces 8 present on the basic frame 21, it is also possible for two bundle stuffing units 10 and two further functional units 9, for example finishing units or material fillers 11, to be provided on a basic module 2 of the basic module type 2a.

The modules 2, 3, 4 of the different module types are in each case configured as autonomously operable units. This means that the modules 2, 3, 4 have the electrical/electronic installations 23 required for the operation thereof. These installations 23 herein also comprise output and/or control units, in as far as the latter are required for the functioning of the respective module 2, 3, 4.

Moreover, the modules 2, 3, 4 in the shipping state are completely electrically wired and optionally equipped with hydraulic and/or pneumatic lines and connectors. Installing and commissioning a brush production machine 1 that is produced from the different modules 2, 3, 4 of the construction kit is therefore possible without a great effort and without installing electrical lines. This applies in particular when respective plug connections by way of which the individual modules 2, 3, 4 can also be interconnected in terms of a switching circuit are used as coupling elements 7.

As has already been explained above, the guides 14, 18 of the modules 2, 3, 4 of each of the brush production machines 1 illustrated in FIGS. 3 to 8 form a closed transport path. The transport installation 15 of the brush production machine 1 can revolve on this transport path between the individual modules 2, 3, 4 and through or over the latter, in order for workpieces, presently specifically bristle carriers 13 or brush bodies, to be transported. The transport installation 15 comprises transport units 17 that are interconnected in an articulated manner so as to form a transport chain 16. A module length of the basic modules 2 herein is dimensioned such that 19 transport units 17 of the transport chain 16 can be simultaneously disposed in one of the two guides 14 of each of the basic module 2. Two times 19 processing stations within one basic module 2 are thus available.

The transport units 17 herein are freely coupleable such that, as the transport installation 15, a transport chain 16 of an almost arbitrary length can be adapted to the chosen configuration of the brush production machine 1.

As an improvement in the technical field of the production of brush production machines 1, the construction kit for the production of brush production machines 1 is inter alia proposed. This modular construction kit herein comprises at least one basic module type 2a and one deflection module type 3a, the modules 2, 3 thereof having standardized connection interfaces 5 by way of which the modules 3 are inter-coupleable in a simple manner so as to form a brush production machine 1. Since each of the modules 2, 3, 4 is coupleable to each module of the different module types 2a, 3a, 4a from the construction kit, a large number of different brush production machines 1 can be configured using the construction kit, without a particular constructive effort being required to this end.

### LIST OF REFERENCE SIGNS

1 Brush production machine
2 Basic module
2a Basic module type
3 Deflection module
3a Deflection module type
4 Intermediate module
4a Intermediate module type
5 Connection interfaces
6 Connection side
7 Coupling elements
8 Installation interface
9 Functional unit
10 Bundle stuffing unit
11 Material filler
12 Feeding/retrieving unit
13 Bristle carrier
14 Guide
15 Transport installation
16 Transport chain
17 Transport unit
18 Curved guide
19 Entry cross section of 14, 18
20 Exit cross section of 14, 18
21 Basic frame of 2
22 Basic frame of 3
23 Electrical/electronic installation

1. A modular construction kit for the production of brush production machines (1), comprising at least one module of a basic module type (2a) and one module of a deflection module type (3a), wherein the modules (2, 3, 4) of the basic and deflection module types (2a, 3a, 4a) of the construction kit each include mutually compatible connection interfaces (5) by which the modules (2, 3, 4) are inter-coupleable such that a multiplicity of different brush production machines (1) of modular construction are producible with the construction kit.

2. The construction kit as claimed in claim 1, wherein the connection interfaces (5) are disposed on connection sides (6) of the modules (2, 3, 4) of the basic and deflection module types (2a, 3a, 4a).

3. The construction kit as claimed in claim 2, wherein the connection sides (6) of two of the modules (2, 3, 4) that are neighboring face one another in a coupled position.

4. The construction kit as claimed in claim 1, wherein the modules (2, 3, 4) of the basic and deflection module types (2a, 3a, 4a) on the connection interfaces (5) thereof have inter-coupleable coupling elements (7) which in terms of at least one of a number or arrangement thereof are congruent and by way of which the modules (2, 3, 4) are at least one of mechanically, electrically, electronically, pneumatically or hydraulically inter-coupleable.

5. The construction kit as claimed in claim 1, wherein at least one of the modules (2, 3) of the basic module type (2a) or the deflection module type (3a) includes in each case at least one installation interface (8) or a plurality of mutually identical installation interfaces for equipping the modules (2) with functional units (9).

6. The construction kit as claimed in claim 5, wherein the functional units comprise at least one of a bundle stuffing unit (10), a processing unit, a material insert (11), a material box, or a feeding and retrieving unit (12) for feeding and retrieving bristle carriers (13) and or finished brushes.

7. The construction kit as claimed in claim 1, further comprising at least one module of an intermediate module type (4a).

8. The construction kit as claimed in claim 1, further comprising at least one of a module of a feeding module type or a module of a retrieving module type, the module of the feeding module type including at least one supply unit for supplying material and the module of the retrieving module type including at least one retrieving unit for retrieving material.

9. The construction kit as claimed in claim 1, wherein the modules (2a, 3a, 4a) have in each case at least one guide (14) for a transport installation (15) that in terms of conveying technology connects the modules (2, 3, 4) for a transport chain (16) from a plurality of interconnected transport units (17) for bristle carriers (13).

10. The construction kit as claimed in claim 1, further comprising at least one transport installation having transport units (17) that are coupled together to produce the transport installations (15), the modules (2, 3, 4) of a brush production machine (1) being connectable for article conveyance to said transport installations (15).

11. The construction kit as claimed in claim 10, wherein at least one of the deflection modules (3) of the deflection module type (3a), a feeding module of a feeding module type, or a retrieving module of a retrieval module type has in each case at least one of a curved or angled guide (18) by which the transport installation (15) is deflectable by at least one of 45 degrees, 90 degrees, or 180 degrees.

12. The construction kit as claimed in claim 11, further comprising an entry cross section (19) and an exit cross section (20) of the guide (18) of the deflection module (3) is disposed or configured on a connection side (6) of the deflection module (3), or an entry cross section (19) and an exit cross section (20) of a guide (14, 18) of at least one of a feeding or retrieving module are disposed or configured on a connection side (6) of the at least one of the feeding or retrieving module.

13. The construction kit as claimed in claim 12, wherein at least one said module (2) of the basic module type (2a) or a module (4) of an intermediate module type (4a) has in each case at least two guides (14) which are at least one of mutually spaced apart or are mutually parallel, entry cross sections (19) and exit cross sections (20) thereof being disposed on different connection sides (6) of the respective module (2, 4).

14. The construction kit as claimed in claim 13, wherein the guides (14, 18), by way of the exit cross sections (20) thereof, in the case of modules (2, 3, 4) that are in a use position, open into the entry cross sections (19) of the guides (14, 18) of directly neighboring modules (2, 3, 4), or the guides (14, 18) of the modules (2, 3, 4) are interconnectable to form a closed transport path.

15. A brush production machine (1) assembled from the construction kit according to claim 14, including at least one said module (2) of the basic module type, and two said modules (3) of the deflection module type, or at least one said module (2) of the basic module type, one said module (3) of the deflection module type, and at least one of said feeding or retrieving modules.

16. The construction kit as claimed in claim 1, wherein the modules (2) of the basic module type (2a) have a same basic construction with at least one of a same first basic frame or a same encapsulation, and the modules (3) of the deflection module type (3a) have a same basic construction with at least one of a same second basic frame (22) or a same encapsulation.

17. The construction kit as claimed in claim 12, wherein the modules (2) of the basic module type (2a), modules (4) of an intermediate module type (4a), the feeding modules, the retrieving modules, or the modules (3) of the deflection module type (3a) are in each case configured as autonomously operable units, and the modules (2, 3, 4) comprise electrical/electronic installations (23) required for operation of said modules (2, 3, 4), including at least one of power units, control units, electrical wiring, hydraulic lines, or pneumatic lines.

18. A brush production machine (1) produced from modules (2, 3, 4) of the construction kit as claimed in claim 1.

19. The brush production machine (1) as claimed in claim 18, wherein the brush production machine (1) is assembled from at least one said module (3) of the deflection module type and at least said module (2) of said basic module type.

20. The brush production machine (1) of claim 19, further comprising at least of one further said module (3) of the deflection module type, a feeding module, or a retrieving module, and the at least one basic module (2) is disposed between the two deflection modules (3) or between a deflection module (3) and a feeding and retrieving module.

21. The brush production machine (1) as claimed in claim 20, further comprising guides (14, 18) in the modules (2, 3, 4) for a transport installation (15) of the brush production machine (1), by which workpieces are transportable between intercoupled the modules (2, 3, 4) that form a closed revolving transport path on which the transport installation (15) revolves.

22. The brush production machine (1) as claimed in claim 21, wherein the transport installation (15) is a transport chain (16) of interconnected transport units (17).
